(19) United States
(12) Patent Application Publication
(10) Pub. No.: US 2026/0370184 A1
(43) Pub. Date: Nov. 19, 2026

(54) Electronically Excited Water Spray System For Non-Contact Cleaning of Solar Panels

(71) Applicant: Oren Aharon, Haifa (IL)

(72) Inventor: Oren Aharon, Haifa (IL)

(21) Appl. No.: 19/208,613

(22) Filed: May 15, 2025

(51) Int. Cl. H02S 40/10; B08B 3/02; B08B 6/00; B08B 13/00; F24S 40/20

(52) U.S. Cl. CPC H02S 40/10; B08B 3/02; B08B 6/00; B08B 13/00; F24S 40/20

(57) ABSTRACT

A non-contact solar panel cleaning system that utilizes an electrically excited water spray to remove statically adhered dust from solar panels. The system comprises a water pump, a conductive nozzle connected to an alternating voltage source, and a control unit with sensors for monitoring panel and environmental conditions. When activated, a fine mist of water droplets carrying an oscillating electric field is sprayed over the solar panel surfaces, dislodging dust through electrostatic and electrohydrodynamic interactions. This method avoids the use of brushes, reduces wear, and improves cleaning effectiveness.

### BACKGROUND OF THE INVENTION

### 1. Field of the Invention

The invention relates to automated cleaning systems for photovoltaic (PV) modules, and more particularly to systems employing electrically excited water droplets to improve the removal of dust particles from panel surfaces.

### 2. Description of the Related Art

Dust accumulation on solar panels leads to a significant decrease in power conversion efficiency. Traditional cleaning approaches include manual washing or robotic brush-based systems. These methods require human labor or involve mechanical components that are prone to wear and can damage the panel surface. Electrostatic adhesion is a major cause of dust buildup in arid regions. Standard water jets may not dislodge this type of adhesion effectively.

### SUMMARY

The invention provides an automated cleaning apparatus that generates a water spray from a conductive nozzle excited by a low-voltage AC or sinusoidal signal. This system enables electrostatic disruption at the point of dust-particle adhesion.

The system comprises:
1. A water storage tank and delivery pump.
2. A conductive spray nozzle electrically coupled to an AC power source.
3. A programmable microcontroller (e.g., ATMEGA 328) interfaced with sensors and wireless communication.
4. A feedback monitoring system to determine when cleaning is required.

The water is sprayed in a fine mist, with electric excitation enhancing the dislodgement of dust particles via dielectrophoretic and electrohydrodynamic forces.

To summarize, the cleaning system for photovoltaic panels is based on a water reservoir, a water pump, a conductive nozzle connected to the pump, a low-voltage alternating current (AC) power supply connected to said nozzle, and solar panel, at least one photovoltaic panel disposed beneath said nozzle, and wherein water is sprayed from the nozzle while the nozzle is electrically excited, thereby aiding in the dislodgment of dust particles via electrostatic interaction. For control the system is further comprised of a microcontroller configured to control the operation of the pump and the AC power supply. Moreover, the microcontroller can receive input from sensors measuring temperature, voltage, humidity, or solar panel output. The AC signal is sinusoidal with adjustable frequency and amplitude, wherein the nozzle and associated components are insulated to ensure user safety. For remote operations, a cloud-connected server and wireless module for remote monitoring and control. For best performance the water spray is atomized into fine droplets to maximize surface contact and coverage. Said electrically excited mist operates to disrupt electrostatic adhesion via electrohydrodynamic and dielectrophoretic forces, comprising an automated control relay, and a timer for scheduled operation. Said nozzle is one of a plurality of nozzles arranged along a spray bar positioned above an array of solar panels.

### BRIEF DESCRIPTION OF THE DRAWINGS

FIG. 1: Side-view diagram of a gravity-assisted cleaning system using a water pump and reservoir to deliver cleaning solution through a series of nozzles along the panel top edge.

FIG. 2: Schematic illustration of an electrically excited water spray interacting with dust-covered solar panels. The conductive nozzle emits mist excited by an AC power source, which breaks electrostatic adhesion on the panels

### DETAILED DESCRIPTION OF THE DRAWINGS

In operation, when the sensors detect a drop in panel efficiency or rising ambient dust levels, the microcontroller activates the water pump. Water is drawn from the storage tank to the non-conductive spray tank and pumped through the conductive nozzle. Simultaneously, the AC power source applies a low-voltage oscillating signal to the nozzle. The resulting spray consists of charged or polarized water droplets that interact with dust particles on the solar panel surface. A thin layer of charged water will form over the solar panel and will enhance dust particle removal and wash them away.

Electrohydrodynamic spraying increases the cleaning efficiency by modifying droplet trajectories and enhancing droplet-particle interaction. The applied field may also reduce surface tension, creating finer mist distribution and improved coverage.

Safety is ensured through grounding of components, use of insulated wiring, and integration of moisture sensors to detect leak conditions. The system may operate autonomously or be triggered remotely via the cloud-based monitoring interface.

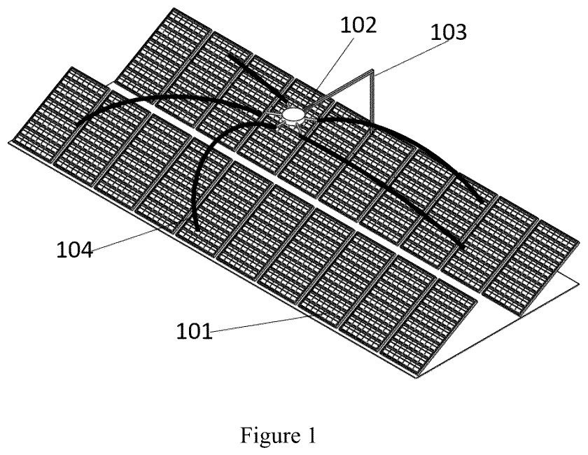

FIG. 1 is prior art schematic illustration of a non-contact water washing device based on multiple nozzles arranged to cover several panels with water jets. The water will wash out most of the dust. However, the electro-static attached dust particle to the solar panels will not be removed by simple washer. The needed to be washed solar panels denoted as 101 are washed with water jets. The water jets are produced through multiple nozzles denoted as 102 to spray water jets denoted as 104. The said multiple nozzle device is securely held above the solar panel using the member 104.

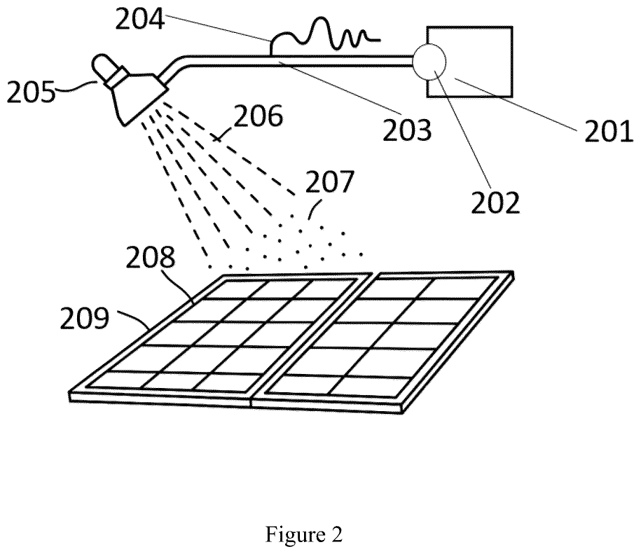

FIG. 2 is a schematic representation of my new novel Electrically Excited Water Spray System enhancing cleaning effect by electrifying the water jet to overcome the electro-static adhesive power between dust particles and solar panels. The intermediate non-conducting tank denoted as 201 provides water to be sprayed at the solar panel for cleaning purposes. The water is pumped the 202 pump through a tube denoted as 203 sinusoidal voltage denoted as 204 is applied to the tube and to the nozzle denotes as 205. Charged water is sprayed and denoted as 206 further creating droplets denoted as 207. The dust particles denoted as 208 are removed by created voltage effect. The frame of the panels denoted as 209 is connected to the earth which is a standard procedure for solar panels.

1. A cleaning system for photovoltaic panels comprising:
a non-conductive water tank;
a water pump;
a conductive nozzle connected to the pump;
a low-voltage alternating current (AC) power supply connected to said nozzle;
at least one photovoltaic panel disposed beneath said nozzle; and
wherein water is sprayed from the nozzle while the nozzle is electrically excited, thereby aiding in the dislodgment of dust particles via electrostatic interaction.

2. The system of claim 1, further comprising a microcontroller configured to control the operation of the pump and the AC power supply.

3. The system of claim 2, wherein the microcontroller receives input from sensors measuring temperature, voltage, humidity, or solar panel output.

4. The system of claim 1, wherein the AC signal is sinusoidal with adjustable frequency and amplitude.

5. The system of claim 1, wherein the nozzle and associated components are insulated to ensure user safety.

6. The system of claim 1, further comprising a cloud-connected server and wireless module for remote monitoring and control.

7. The system of claim 1, wherein the water spray is atomized into fine droplets to maximize surface contact and coverage.

8. The system of claim 1, wherein the electrically excited mist operates to disrupt electrostatic adhesion via electrohydrodynamic and dielectrophoretic forces.

9. The system of claim 1, further comprising an automated control relay, and a timer for scheduled operation.

10. The system of claim 1, wherein said nozzle is one of a plurality of nozzles arranged along a spray bar positioned above an array of solar panels.
